(19) United States
(12) Patent Application Publication
(10) Pub. No.: US 2016/0066628 A1
(43) Pub. Date: Mar. 10, 2016

(54) Wearable Towel and Changing Surface

(71) Applicants: Joan Shakes, Austell, GA (US); Yvonne Shakes, Austell, GA (US)

(72) Inventors: Joan Shakes, Austell, GA (US); Yvonne Shakes, Austell, GA (US)

(21) Appl. No.: 14/476,816

(22) Filed: Sep. 4, 2014

(51) Int. Cl. A41D 13/04; F26B 5/16; A41B 13/06

(52) U.S. Cl. CPC A41D 13/04; A41B 13/06; F26B 5/16

(57) ABSTRACT

A wearable towel device is provided that serves as a drying towel, a diaper changing surface, and a swaddling device. The device comprises an elongated length with an inner surface and an outer surface, along with an upper neck cutout and shoulder regions. At least one of the shoulder regions includes a hood thereover to form over a child held by the wearer. A first and second side strap extends along the sides of the device, while neck straps extend from the neck cutout. The wearer places his or her arms through the side straps and ties the neck straps around the back of his or her neck, while the outer surface of the device can be used in direct contact with a child. Finally, a pocket for storing diapers and other supplies is disposed along the inner surface.

### BACKGROUND OF THE INVENTION

1. Field of the Invention

The present invention relates to aprons and infant towels that can be worn by the user. More specifically, the present invention pertains to an apron towel that is used to dry and wrap an infant after a bath, and furthermore one that is adapted to provide a hood for the child along one or both shoulders thereof.

Bathing or changing an infant child can be a messy task, particularly if the child is fussy. After a bath, many babies can become very fussy if not wrapped up in a towel immediately and dried. This can be problematic for parents, as they have to quickly retrieve a towel while holding onto their wet child. This process often results in the soaking of parents' clothing. If the baby starts to squirm or kick, the parent may also accidently drop the baby, which can be extremely dangerous.

Similarly, changing a baby in a public area can sometimes be a difficult task. The baby must be placed on a changing table or similar support, while the parent removes soiled diapers, cleans the child and then replaces the diaper. A clean changing table is not always available; therefore many parents bring towels or blankets with them while traveling to place the child on the blanket during the changing operation.

A towel or blanket is therefore required for both of these exercises. However, many baby towels are small and unaccommodating for these tasks. The present invention is presented as a new and novel baby towel arrangement that can be body worn by the parent or caregiver. The device comprises an elongated towel that forms a body covering, a baby swaddling wrap and a changing surface all in one. The device has a first surface comprising a soft, preferably terry cloth material, and a backside cotton surface placed against the wearer. One or more head pockets are disposed along the upper portion of the device to enclose an infant's head while holding the same, while an interior surface pocket supports replacement diapers and other accessories. A first and second side strap allow the wearer to secure the sides of the device around the wearer's arms, while a neck cutout and necktie straps are used to secure the upper portion of the device about the wearer's neck. Overall the device is a multifunctional baby drying, changing, and swaddling device that is comfortable for the child and protective of the wearer's clothes.

2. Description of the Prior Art

Devices have been disclosed in the prior art that relate to wearable towels and baby swaddling devices. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

One such device in the art is U.S. Pat. No. 8,276,212 to Quintanilla, which discloses a diamond-shaped apron and towel device that is worn by a user and includes a pair of slits therethrough to accept the arms of the user while the device is being donned. The garment closes around the user's neck at its upper end and around the waist about its midsection. The lower end includes a hood that can cover the child. Overall, the device is used to hold a child, dry the child or swaddle the child, either while donned by the user or separated therefrom. While disclosing a device that covers a child and connects to the user caregiver, the Quintanilla diverges from the present invention in structure. The present invention includes a wearable apron with a hooded region disposed along the upper shoulder portion thereof while donned.

Another device is U.S. Pat. No. 7,685,648 to Kenney, which discloses a wearable bath towel bib that includes a collar portion adapted to securably attach around the user's neck region. A portion of the towel extends around the neck of the wearer and secures to the towel to form a closed loop, while the towel drapes across the user's body to form a towel and a swaddle for an infant. The Kenney towel device is an example of a simple, wearable bath towel that can be used to dry and swaddle an infant while bathing. The present invention comprises a wearable towel but contemplates a hood or infant head covering pouch disposed on one of the shoulder regions thereof.

U.S. Patent Publication No. 2006/0143769 to Pathak discloses an article adapted for wearing by a user that can support a baby after a bath, wherein the device comprises a body portion and an optional hood portion. The present invention contemplates a body worn device having a terry cloth first surface and a cotton backside surface, whereby the device is secured over the shoulders of the wearer and around the arms thereof. The present invention contemplates side arm straps in combination with neck straps to facilitate connection of the device to the wearer and improved use. Finally, an interior pocket is provided for storage of replacement diapers and other child supplies. One or more shoulder pockets are present for covering the head of a child swaddled within the device.

Finally, U.S. Pat. No. 3,629,865 to Weiner discloses a substantially square shaped apron that can be worn by the user for drying a child. One corner of the device includes a partially separated portion that can be used to secure around the neck of the wearer and reattach to the device to form a neck opening. Further contemplates are pockets to receive and hold objects along the edge of the device. While the Weiner device discloses a wearable device for holding and drying a child, its structure diverges from that of the present invention. The present invention contemplates a two-material construction, one that includes arm straps, and one or more head pockets for the child's head to be covered while swaddled.

It is submitted that the present invention is substantially divergent in design elements from the prior art, and consequently it is clear that there is a need in the art for an improvement to existing wearable towel devices. In this regard the instant invention substantially fulfills these needs.

### SUMMARY OF THE INVENTION

In view of the foregoing disadvantages inherent in the known types of wearable towel and baby swaddling devices now present in the prior art, the present invention provides a new wearable device that can be utilized for providing convenience for the user when drying a baby after a bath, providing a clean diaper changing surface, or for swaddling the child using a wearable assembly.

It is therefore an object of the present invention to provide a new and improved wearable towel device that has all of the advantages of the prior art and none of the disadvantages.

It is another object of the present invention to provide a wearable towel device that can be used as a swaddling cloth, a bath towel, and a changing surface, whereby the wearer's clothes are protected and the child is contacted with a soft, comfortable surface.

Another object of the present invention is to provide a wearable towel device that includes at least one hooded shoulder so as to receive the head of a child and dry the same.

Yet another object of the present invention is to provide a wearable towel device that includes arm straps that extend from the sides of the device and a neck hole with neck straps therearound, whereby the towel device is secured about the neck and arms of the wearer.

Another object of the present invention is to provide a wearable towel device that includes an inner layer that touches the wearer and an outer layer that is adapted to contact the child when drying, changing, or covering the same.

Another object of the present invention is to provide a wearable towel device that includes easily securable neck straps that can be placed in a slip knot configuration for ease of attachment and removal.

A final object of the present invention is to provide a wearable towel device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal view of an embodiment of the present invention, wherein the outer surface is shown.

FIG. 2 shows a rear view of an embodiment of the present invention, wherein the inner surface and interior pouch is shown.

FIG. 3 shows a view of the hooded shoulder portion being exposed to accept the head of a baby therein.

FIG. 4 shows yet another embodiment of the present invention.

FIG. 5 shows a view of the present invention in a working state.

FIG. 6 shows a view of the present invention in a working state.

### DETAILED DESCRIPTION OF THE INVENTION

Reference is made herein to the attached drawings. Like reference numerals are used throughout the drawings to depict like or similar elements of the wearable towel device of the present invention. For the purposes of presenting a brief and clear description of the present invention, the preferred embodiment will be discussed as used for drying a baby after a bath, providing a changing surface when changing a diaper, and for swaddling a child in a comfortable blanket. The figures are intended for representative purposes only and should not be considered to be limiting in any respect.

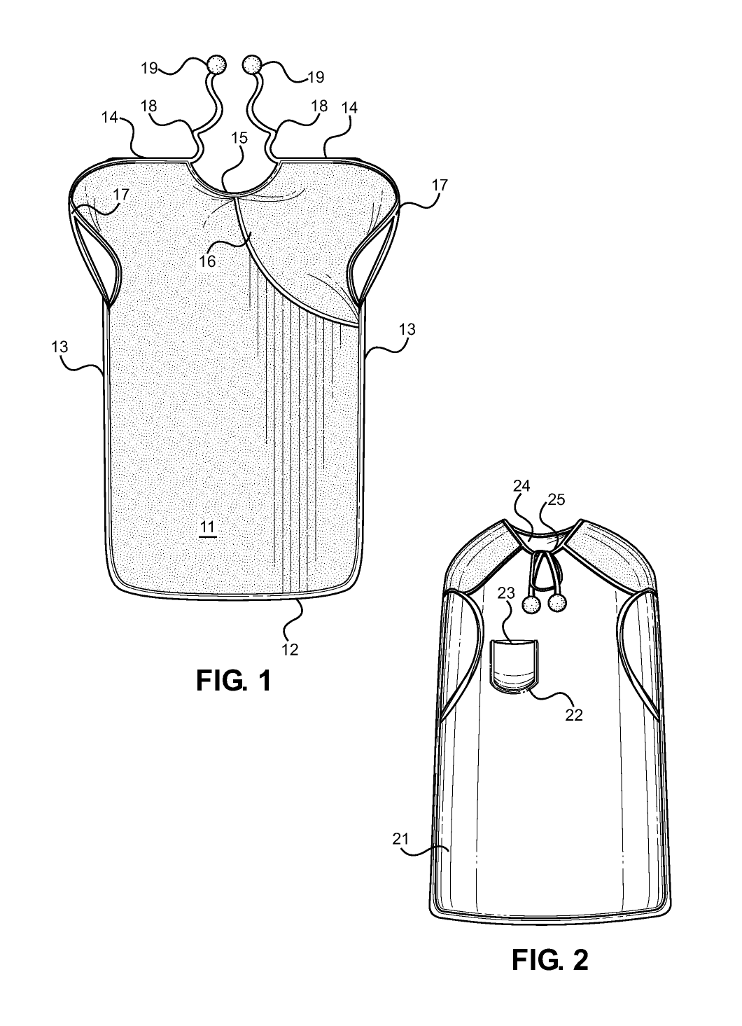

Referring now to FIG. 1, there is shown a frontal view of the wearable towel device of the present invention. The device comprises an elongated length of material having an outer surface 11 and an inner surface, whereby the outer surface 11 preferably comprises soft, terry cloth material that assists with removing and absorbing moisture from a child cradled thereby. The inner surface preferably comprises a cotton cloth material that protects the wearer's clothes from moisture, waste, and spit-up from a baby.

The device comprises a first and second side edge 13, a lower edge 12 and an upper edge 14 to form a substantially rectangular shape. The upper edge 14 is adapted to be worn over the shoulders of a wearer, while a neck cutout region 15 is disposed therealong that receives the neck of the wearer. A first and second neck strap 18 extend from the cutout and include enlarged distal ends 19 that facilitate handling and tying of the straps 18 around the backside of the wearer's neck. Once secured to the neck, the device drapes over the front of the wearer and provides a barrier and towel structure for drying a wet baby, cradling and swaddling the same, and finally for providing an enlarged changing surface when changing diapers.

Disposed adjacent to the neck cutout 15 and below the upper edge 14 is one or more hood surfaces 16, which are adapted to cover the shoulder portion of the wearer and provide a hood pocket therealong. The hood pocket is used to secure over a child's head when drying the same. This prevents the baby from becoming cold and quickly dries the baby after a bath. Furthermore, the hooded pocket can serve to shroud the eyes of the child and allow the child to rest or sleep more easily while covered.

Referring now to FIGS. 1 and 2, disposed along the side edges 13 of the device and extending to the junction of the upper edge 14 and side edges 13 on both sides of the device is a side strap 17. The side straps 17 are elongated strap members that connect at both ends to the edges of the device, and provide an armhole through which the wearer places his or her arm therethrough. This allows the wearable towel device to be supported by the neck straps 18 and by the shoulders of the wearer, wherein the device remains close to the wearer's chest when the side straps 17 are placed along the backside of the wearer's arms. The lower part of the device continues to hang freely and unsupported, wherein the same can be folded upwards or outwards when either carrying a child or providing an elongated changing surface.

Referring specifically to FIG. 2, there is shown a backside view of the wearable towel of the present invention. The inner surface 21 comprises a cotton material layer that is adapted to be in contact with the wearer's clothes while in use. Along the inner surface 21 is disposed one or more storage pockets 22 therealong, which each include an internal volume and an open upper 23 to receive diapers and other baby supplies. This pocket 22 is useful when the device is deployed as a changing table cover, whereby diapers, powder, and other supplies can be quickly accessed while the baby is supported on a surface and on the outstretched towel device. Further provided in FIG. 2 is a view of the neck cutout being formed into an enclosed opening 24, whereby the neck straps are tied together in a knot 25 to secure the device around the neck of the wearer.

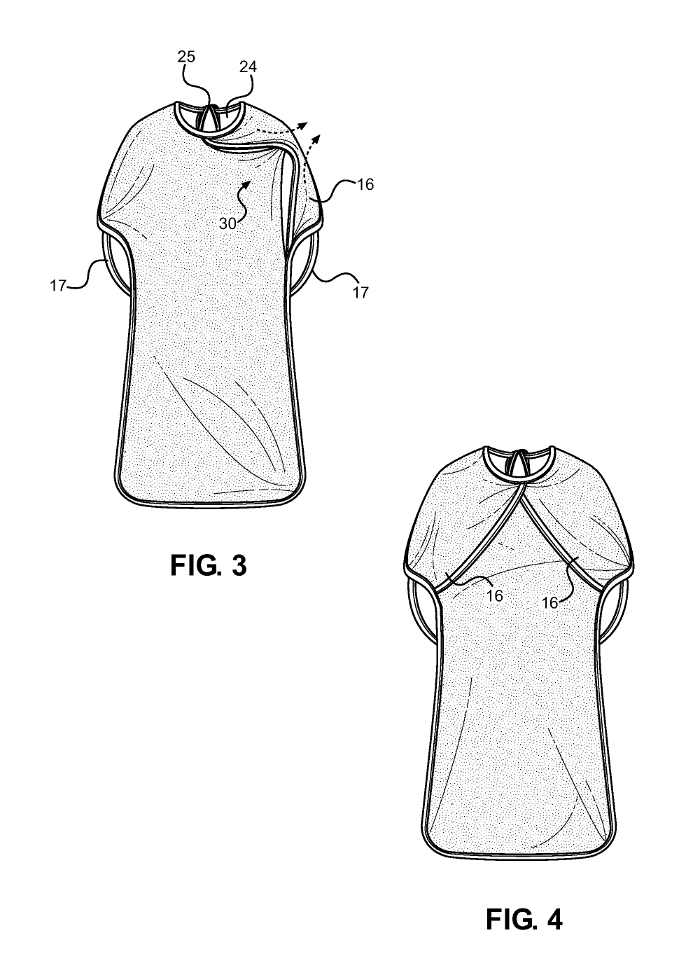

Referring now to FIG. 3, there is shown a frontal view of the wearable towel of the present invention, whereby the hood pocket 30 is being displayed as the hood 16 is pulled away from the outer surface of the device. As illustrated, the hood 16 is a surface disposed over the shoulder region of the device and connected thereto along the side and upper edges thereof. The lower edge of the hood 16 is free such that the lower edge can be pulled away from the device to expose and expand the hood pocket region 30. The neck strap knot 25 and the side straps 17 secure the towel to the user while the hood 16 is opened.

Referring now to FIG. 4, there is shown a frontal view of an embodiment of the present invention, wherein a first and second hood portion 16 is provided along the shoulder region of the device. This embodiment shows that more than one hood portion 16 may be disposed along the upper shoulder region of the device to accommodate more than one child or for supporting a single child from either the left or right shoulder of the wearer.

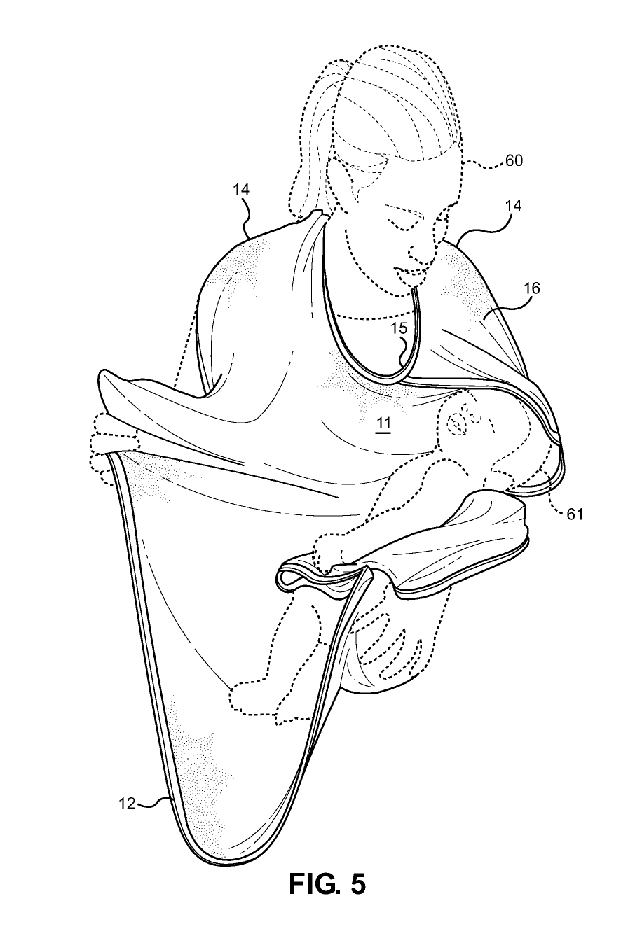

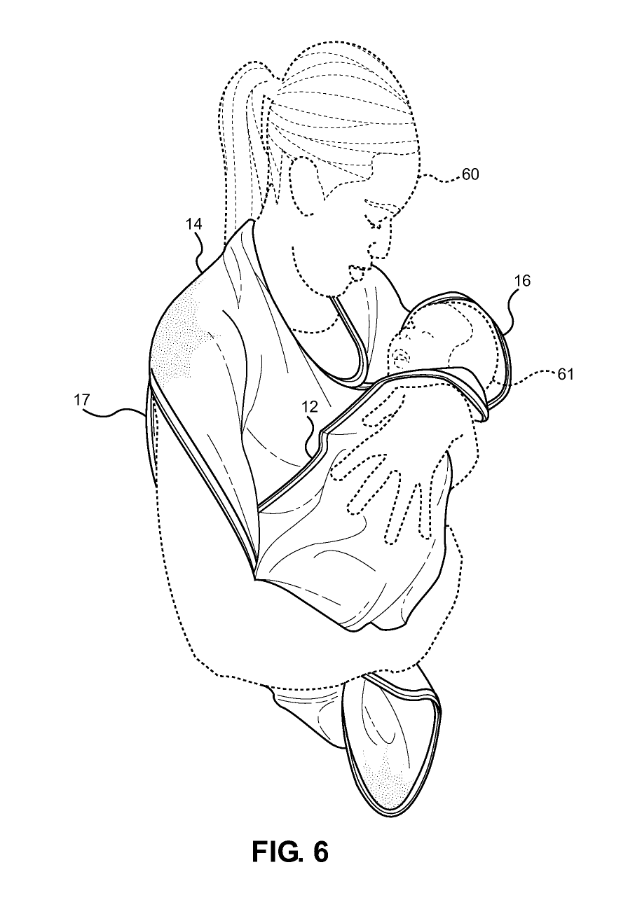

Referring now to FIGS. 5 and 6, there are shown two views of the present invention in a working state, whereby a user 60 is wearing the device and supporting a child 61 therein. As shown, the upper edges 14 drape over the shoulders of the wearer 60, while the neck cutout 15 provides space for the wearer's neck. The outer surface 11 of the device is used to cradle a child 61 as the lower edge 12 and side edges are wrapped therearound the dry and comfort the child. To retain the device on the wearer, the side straps 17 and neck straps secure the side edges and upper edges to the wearer, respectively. The hood 16 can be opened and placed over the head of the child 61 to assist drying or to comfort the child while swaddling or cradling the child in the wearer's arms.

Overall, the present invention is a new and useful multi-purpose baby towel that is wearable and sufficiently structured to facilitate several functions. The device is designed to help with the safe handling of infants during care, to dry a child after a bath, to comfort a crying child and cover the wearer, and to provide a surface upon which a child's diaper can be changed. During bathing periods, the device allows wearers to carefully handle a baby with a much lowered risk of dropping the baby, while enabling total dedication of both hands towards safe lifting and transferring of baby. The device also greatly reduces anxiety of both caregiver and child by providing a comfortable surface for the child and a protective cover over the wearer, thus providing a more efficient, more pleasant and calming experience for all involved during bath time.

The inner surface of the device offers greater protection of a caregiver's clothing while changing or grooming a child anywhere and anytime, and without the need for a changing station. As a caregiver frequently experiences situations in which there are no designated changing stations, the caregiver must often times improvise by using his or her lap as the changing area. This poses the challenge of successfully cleaning the child (usually an anxious squirming baby) on the caregiver's lap and on a crumpled towel, while trying to protect the caregiver's clothing soiling in the process. The outer surface of the device is highly absorbent and provides a wide surface area to cover the wearer's entire lap while seated.

The inner surface of the towel is lined with a 100% cotton material that is comfortable against the wearer and suitable for protecting the wearer while burping a baby after feeding. This function is even more beneficial to parents/caregivers of teething infants or infants more prone to spitting or vomiting especially while on the go. The pocket disposed along the inner surface is located along the chest area of the wearer to hold diapers, diaper cream, powder and the like for easy access while handling a baby during cleaning activities. The pocket lies flat when not in use and does not affect the comfort aspect of the towel while using it for its other functions.

The hood along either the left or right shoulder of the device is sized such that it easily accommodates the size of a newborn head and up to a few years old. The hood dries the head of the child and further can function as a light shroud while holding the child. Both of these functions calm the child and facilitate calmer handling.

Overall, it is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wearable towel device, comprising:
an elongated towel having a first side edge, a second side edge, an upper edge, and a lower edge;
a neck cutout disposed along said upper edge;
a first and second neck strap extending from said upper edge and disposed adjacent to said neck cutout;
said elongated towel having an outer surface, an inner surface, and a shoulder region disposed adjacent to said neck cutout along said outer surface;
at least one hood disposed along said shoulder region, each hood connected to one of said side edges and said upper edge, and further having a free edge to form an interior volume between said hood and said outer surface;
a first side strap disposed along said first side edge, said first side strap having a first and second end connected to said first side edge;
a second side strap disposed along said second side edge, said second side strap having a first and second end connected to said second side edge.

2) The wearable towel device of claim 1, further comprising a pocket disposed along said inner surface.

3) The wearable towel device of claim 1, wherein said outer surface comprises a terry cloth material.

4) The wearable towel device of claim 1, wherein said inner surface comprises a cotton material.

5) A wearable towel device, comprising:
an elongated towel having a first side edge, a second side edge, an upper edge, and a lower edge;
a neck cutout disposed along said upper edge;
a first and second neck strap extending from said upper edge and disposed adjacent to said neck cutout;
said elongated towel having an outer surface, an inner surface, and a shoulder region disposed adjacent to said neck cutout along said outer surface;
at least one hood disposed along said shoulder region, each hood connected to one of said side edges and said upper edge, and further having a free edge to form an interior volume between said hood and said outer surface;
a pocket disposed along said inner surface.

6) The wearable towel device of claim 5, further comprising:
a first side strap disposed along said first side edge, said first side strap having a first and second end connected to said first side edge;
a second side strap disposed along said second side edge, said second side strap having a first and second end connected to said second side edge.

7) The wearable towel device of claim 5, wherein said outer surface comprises a terry cloth material.

8) The wearable towel device of claim 5, wherein said inner surface comprises a cotton material.
